(19) United States
(12) Patent Application Publication
(10) Pub. No.: US 2014/0222699 A1
(43) Pub. Date: Aug. 7, 2014

(54) HEAT TRANSFER COMPOSITIONS

(71) Applicant: MEXICHEM AMANCO HOLDING S.A. de C.V., Estado de Mexico c.p. (MX)

(72) Inventor: Robert Elliott Low, Cheshire (GB)

(21) Appl. No.: 14/237,155

(22) PCT Filed: Aug. 2, 2012
(86) PCT No.: PCT/GB2012/051870

§ 371 Date: Apr. 17, 2014

(30) Foreign Application Priority Data
Aug. 5, 2011 (GB) 1113562.1

(51) Int. Cl. C09K 5/04; C08J 9/12; G06Q 30/00; C11D 3/43; B01D 11/02; B01D 11/04; C08J 9/14; C09K 3/30

(52) U.S. Cl. CPC C09K 5/045; C08J 9/146; C08J 9/122; C09K 3/30; C08J 9/127; C11D 3/43; B01D 11/0288; B01D 11/0492; G06Q 30/018; C09K 2205/40; C09K 2205/106
USPC 705/317; 252/67; 252/68; 516/12; 521/97; 516/8; 423/658.5; 252/364; 510/461; 62/498; 62/119; 432/1; 62/77

(57) ABSTRACT

The invention provides a heat transfer composition comprising up to about 30% by weight carbon dioxide (R-744), from about 30% to about 80% by weight difluoromethane (R-32), and 1,3,3,3-tetrafluoropropene (R-1234ze).

The invention relates to heat transfer compositions, and in particular to heat transfer compositions which may be suitable as replacements for existing refrigerants such as R-134a, R-152a, R-1234yf, R-22, R-410A, R-32, R-407A, R-407B, R-407C, R-407F, R507 and R-404A.

The listing or discussion of a prior-published document or any background in the specification should not necessarily be taken as an acknowledgement that a document or background is part of the state of the art or is common general knowledge.

Mechanical refrigeration systems and related heat transfer devices such as heat pumps and air-conditioning systems are well known. In such systems, a refrigerant liquid evaporates at low pressure taking heat from the surrounding zone. The resulting vapour is then compressed and passed to a condenser where it condenses and gives off heat to a second zone, the condensate being returned through an expansion valve to the evaporator, so completing the cycle. Mechanical energy required for compressing the vapour and pumping the liquid is provided by, for example, an electric motor or an internal combustion engine.

In addition to having a suitable boiling point and a high latent heat of vaporisation, the properties preferred in a refrigerant include low toxicity, non-flammability, non-corrosivity, high stability and freedom from objectionable odour. Other desirable properties are ready compressibility at pressures below 25 bars, low discharge temperature on compression, high refrigeration capacity, high efficiency (high coefficient of performance) and an evaporator pressure in excess of 1 bar at the desired evaporation temperature.

Dichlorodifluoromethane (refrigerant R-12) possesses a suitable combination of properties and was for many years the most widely used refrigerant. Due to international concern that fully and partially halogenated chlorofluorocarbons were damaging the earth's protective ozone layer, there was general agreement that their manufacture and use should be severely restricted and eventually phased out completely. The use of dichlorodifluoromethane was phased out in the 1990's.

Chlorodifluoromethane (R-22) was introduced as a replacement for R-12 because of its lower ozone depletion potential. Following concerns that R-22 is a potent greenhouse gas, its use is also being phased out.

Whilst heat transfer devices of the type to which the present invention relates are essentially closed systems, loss of refrigerant to the atmosphere can occur due to leakage during operation of the equipment or during maintenance procedures. It is important, therefore, to replace fully and partially halogenated chlorofluorocarbon refrigerants by materials having zero ozone depletion potentials.

In addition to the possibility of ozone depletion, it has been suggested that significant concentrations of halocarbon refrigerants in the atmosphere might contribute to global warming (the so-called greenhouse effect). It is desirable, therefore, to use refrigerants which have relatively short atmospheric lifetimes as a result of their ability to react with other atmospheric constituents such as hydroxyl radicals, or as a result of ready degradation through photolytic processes.

With the need to switch from ozone-depleting refrigerants, R-22 has recently been supplanted by R-407 refrigerant family members (including R-407A, R-407B R407C and R-507F) and, in particular, R-410A (a mixture of difluoromethane (R-32) and pentafluoroethane (R-125) 50/50 by weight) as preferred refrigerant for residential and commercial air conditioning and heat pump systems. Although R-410A has worse theoretical performance than R-22, in practice R-410A systems offer improved energy efficiency. This is because it is a higher-pressure fluid than R-22 and so pipework and compressors can be made smaller, pressure drop losses in the refrigeration circuit can thereby be reduced and performance can be improved. R-410A also exhibits superior heat transfer performance to R-22 because of its R-32 content as a secondary consequence of the higher operating pressures in the equipment and the improved thermal transport properties of R-32.

The environmental impact of operating an air conditioning, refrigeration or heat pump system, in terms of the emissions of greenhouse gases, should be considered with reference not only to the so-called “direct” GWP of the refrigerant, but also with reference to the so-called “indirect” emissions, meaning those emissions of carbon dioxide resulting from consumption of electricity or fuel to operate the system. Several metrics of this total GWP impact have been developed, including those known as Total Equivalent Warming Impact (TEWI, the sum of the indirect and direct emissions) analysis, or Life-Cycle Carbon Production (LCCP) analysis. Both of these measures include estimation of the effect of refrigerant GWP and energy efficiency on overall warming impact. Emissions of carbon dioxide associated with manufacture of the refrigerant and system equipment should also be considered.

R-410A systems show lower TEWI scores than R-22 systems because their energy consumption is better and so less electricity is used in their operation, leading to less emission of carbon dioxide from power stations. R-410A is non-flammable as assessed by the ASHRAE Standard 34 methodology. The R-125 content in the refrigerant ensures this non-flammability but it reduces the performance of the refrigerant below that which could be expected if R-32 were used alone. In addition, it raises the Global Warming Potential of the refrigerant from 675 (the value for R-32) to 2088, which is higher than that of R-22. The high GWP of R-410A and the R-407 refrigerants has restricted their applicability.

R-32 has potential to offer further improved TEWI scores compared to R-410A by virtue of enhanced energy efficiency, somewhat higher theoretical cooling capacity and lower GWP. However, it can display high compressor discharge temperatures and to ensure long operating life for refrigerant and lubricant these may require some of the refrigerant capacity and energy efficiency advantages over R-410A to be sacrificed to reduce the discharge temperature. For example compressor discharge temperature can be reduced by injecting condensed liquid refrigerant into the compressor so that it vaporises in the hot gas, thereby cooling it down. A further disadvantage of R-32 is that it is flammable.

The use of carbon dioxide and R-32 as refrigerant has been proposed by, for example, Adams and Stein (J. Chem. Eng. Data, 16(2), 1971, pages 146-149). Mixtures consisting essentially of R-744 and R-32 have been disclosed in U.S. Pat. No. 7,238,299 B2. These mixtures contain sufficient carbon dioxide to render R-32 non-flammable, at least 45% on a molar (volumetric) basis. This means that the critical temperature of the refrigerant is reduced significantly below that of R-410A (it is estimated that the critical temperature of a 45%/55% (v/v) mixture of R-744/R-32 is 62° C., which is about 10° C. lower than R-410A). If the critical temperature of the refrigerant is reduced, then the theoretical vapour compression cycle efficiency is also reduced. These mixtures therefore suffer from significantly reduced efficiency as compared to either R-410A or R-32. Furthermore, the mixtures exhibit compressor discharge temperatures, which are comparable or higher than those of R-32 itself.

It is desirable therefore to improve the performance of R-32 for air conditioning, refrigerant and heat pump applications by addressing the following less desirable characteristics (while trying to maintain capacity and operating pressures equivalent to R-410A):
Global Warming Potential (GWP)
Flammability; considering ignition energy, flame speed and heat of combustion together as aspects of flammability
Compressor discharge temperature

We have found that this can be effectively accomplished using a composition comprising carbon dioxide (R-744), difluoromethane (R-32) and trans-1,3,3,3-tetrafluoropropene (R-1234ze(E)). Specifically, the invention provides a composition comprising up to about 30% by weight R-744, from about 30 to about 80% by weight R-32, and R-1234ze(E).

Surprisingly, the compositions of the invention typically have theoretical energy efficiencies close or comparable to R-32, and higher than R-410A, with comparable cooling/heating capacities to R-410A and reduced GWP and flammability relative to R-32.

Preferably, the compositions of the invention contain from about 4 to about 30% by weight of R-744, such as from about 4 to about 20% by weight. Advantageously, R-744 content is from about 4 to about 12% by weight or from about 5 to about 12% by weight (e.g. about 6 to about 10%).

The R-32 content in the compositions of the invention typically is selected such that the mean condensing pressure is maintained within about 0.5 to 1 bar of the equivalent condensing pressure obtained using R-410A, and/or such that the compressor discharge temperature is lower than that obtained using R-32.

Preferably, the compositions of the invention contain from about 45 to about 80% by weight of R-32.

In a preferred aspect of the invention, the composition comprises from about 4 to about 12% by weight R-744, from about 45 to about 80% by weight R-32 and from about 8 to about 51% by weight R-1234ze(E).

Advantageously, the compositions of the invention contain from about 5 to about 12% by weight R-744, from about from about 50 to about 75% by weight R-32 and from about 13 to about 45% by weight R-1234ze(E).

In one aspect, the compositions of the invention contain from about 6 to about 10% by weight R-744, from about from about 55 to about 75% by weight R-32 and from about 15 to about 39% by weight R-1234ze(E).

Certain preferred compositions of the invention contain from about 4 to about 8% by weight R-744, from about 65 to about 70% by weight R-32 and from about 22 to about 31% by weight R-1234ze(E). Such compositions are believed to offer comparable capacity and operating pressure to R-410A with temperature glide of 5-7 K, comparable to the temperature glides of commercially used refrigerants such as R-407C.

The condenser temperature glide (defined as the difference in condensing dewpoint and bubblepoint temperatures) of the compositions of the invention is preferably 10 K or lower. Accordingly, the effectiveness of heat exchange in a cross-flow condenser should not be significantly reduced compared to R-410A.

All of the chemicals herein described are commercially available. For example, the fluorochemicals may be obtained from Apollo Scientific (UK).

Typically, the compositions of the invention contain trans-1,3,3,3-tetrafluoropropene (R-1234ze(E)). The majority of the specific compositions described herein contain R-1234ze(E). It is to be understood that some of the R-1234ze(E) in such compositions can be replaced by cis-1,3,3,3-tetrafluoropropene (R-1234ze(Z)). The trans isomer is currently preferred, however.

The R-32 content is selected so that the mixture has a lower flammable limit in air at ambient temperature (e.g. 23° C.) (as determined in the ASHRAE-34 12 litre flask test apparatus) which is greater than 5% v/v, preferably greater than 6% v/v, most preferably such that the mixture is non-flammable.

As used herein, all % amounts mentioned in compositions herein, including in the claims, are by weight based on the total weight of the compositions, unless otherwise stated.

For the avoidance of doubt, it is to be understood that the stated upper and lower values for ranges of amounts of components in the compositions of the invention described herein may be interchanged in any way, provided that the resulting ranges fall within the broadest scope of the invention.

In one embodiment, the compositions of the invention consist essentially of (or consist of) R-744, R-32 and R-1234ze(E).

By the term “consist essentially of”, we mean that the compositions of the invention contain substantially no other components, particularly no further (hydro)(fluoro)compounds (e.g. (hydro)(fluoro)alkanes or (hydro)(fluoro)alkenes) known to be used in heat transfer compositions. We include the term “consist of” within the meaning of “consist essentially of”.

For the avoidance of doubt, any of the compositions of the invention described herein, including those with specifically defined compounds and amounts of compounds or components, may consist essentially of (or consist of) the compounds or components defined in those compositions.

Some minor addition of other components to the basic ternary composition may be suitable for improving the compatibility with lubricant or reducing the flammability of the refrigerant. Minor proportions (less than about 10% by weight, preferably less than about 5% by weight) of propylene, propane or isobutene may conveniently be incorporated to improve solubility of the refrigerant in mineral oil or synthetic hydrocarbon lubricants such as alkyl benzenes.

Addition of minor amounts of R-134a and/or R-125 refrigerants to the compositions of the invention (e.g. up to 20% by weight) may also be suitable to further reduce the flammability of the composition of the invention or to render it non-flammable for example when assessed using ASHRAE Std 34 methodology.

Compositions according to the invention conveniently comprise substantially no R-1225 (pentafluoropropene), conveniently substantially no R-1225ye (1,2,3,3,3-pentafluoropropene) or R-1225zc (1,1,3,3,3-pentafluoropropene), which compounds may have associated toxicity issues. Furthermore the compositions preferably comprise substantially no trifluoromethyl acetylene (e.g. less than about 100 or 50 or 40 or 30 ppm), which is reactive and thermally unstable.

By “substantially no”, we include the meaning that the compositions of the invention contain 0.5% by weight or less of the stated component, preferably 0.1% or less, based on the total weight of the composition.

Certain compositions of the invention may contain substantially no cis-1,3,3,3-tetrafluoropropene (R-1234ze(Z)).

The compositions of the invention have zero ozone depletion potential.

Typically, the compositions of the invention have a GWP that is less than 2000, preferably less than 1500, more preferably less than 1000, 900, 800, 700 or 600, especially less than 500 or 400, even less than 300 in some cases. Unless otherwise stated, IPCC (Intergovernmental Panel on Climate Change) AR4 (Fourth Assessment Report) values of GWP have been used herein.

Advantageously, the compositions are of reduced flammability hazard when compared to R-32 alone.

In one aspect, the compositions have one or more of (a) a narrower flammable range; (b) a higher ignition energy; or (c) a lower flame velocity compared to R-32. In a preferred embodiment, the compositions of the invention are non-flammable. Advantageously, the mixtures of vapour that exist in equilibrium with the compositions of the invention at any temperature between about 20° C. and 60° C. are also non-flammable.

Flammability may be determined in accordance with ASHRAE Standard 34 incorporating the ASTM Standard E-681 with test methodology as per Addendum 34p dated 2004, the entire content of which is incorporated herein by reference.

In some applications it may not be necessary for the formulation to be classed as non-flammable by the ASHRAE-34 methodology; it is possible to develop fluids whose flammability limits will be sufficiently reduced in air to render them safe for use in the application, for example if it is physically not possible to make a flammable mixture by leaking the refrigeration equipment charge into the surrounds.

Temperature glide, which can be thought of as the difference between bubble point and dew point temperatures of a zeotropic (non-azeotropic) mixture at constant pressure, is a characteristic of a refrigerant; if it is desired to replace a fluid with a mixture then it is often preferable to have similar or reduced glide in the alternative fluid. In an embodiment, the compositions of the invention are zeotropic.

Advantageously, the volumetric refrigeration capacity of the compositions of the invention is at least 85% of the existing refrigerant fluid it is replacing, preferably at least 90% or even at least 95%.

The compositions of the invention typically have a volumetric refrigeration capacity that is at least 90% of that of R-410A. Preferably, the compositions of the invention have a volumetric refrigeration capacity that is at least 95% of that of R-410A, for example from about 95% to about 120% of that of R-410A.

In one embodiment, the cycle efficiency (Coefficient of Performance, COP) of the compositions of the invention is within about 5% or even better than the existing refrigerant fluid it is replacing

Conveniently, the compressor discharge temperature of the compositions of the invention is lower than that which would be obtained using R-32 in the same application duty and equipment type.

The compositions of the invention preferably have energy efficiency at least 95% (preferably at least 98%) of R-410A and/or R-32 under equivalent conditions, while having reduced or equivalent pressure drop characteristics and cooling capacity at 95% or higher of R-410A values. Advantageously the compositions have higher energy efficiency and lower pressure drop characteristics than R-410A under equivalent conditions. The compositions also advantageously have better energy efficiency and pressure drop characteristics than R-410A.

The heat transfer compositions of the invention are suitable for use in existing designs of equipment capable of using R-410A, and are compatible with all classes of lubricant currently used with established HFC refrigerants. They may be optionally stabilized or compatibilized with mineral oils by the use of appropriate additives.

Preferably, when used in heat transfer equipment, the composition of the invention is combined with a lubricant.

Conveniently, the lubricant is selected from the group consisting of mineral oil, silicone oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof.

Advantageously, the lubricant further comprises a stabiliser.

Preferably, the stabiliser is selected from the group consisting of diene-based compounds, phosphates, phenol compounds and epoxides, and mixtures thereof.

Conveniently, the composition of the invention may be combined with a flame retardant.

Advantageously, the flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

Preferably, the heat transfer composition is a refrigerant composition.

In one embodiment, the invention provides a heat transfer device comprising a composition of the invention.

Preferably, the heat transfer device is a refrigeration device.

Conveniently, the heat transfer device is selected from the group consisting of automotive air conditioning systems, residential air conditioning systems, commercial air conditioning systems, residential refrigerator systems, residential freezer systems, commercial refrigerator systems, commercial freezer systems, chiller air conditioning systems, chiller refrigeration systems, and commercial or residential heat pump systems. Preferably, the heat transfer device is a refrigeration device or an air-conditioning system.

The compositions of the invention are particularly suitable for use as high pressure air conditioning and heat pump fluids, for example in residential unitary systems or in commercial split systems.

The invention also provides the use of a composition of the invention in a heat transfer device as herein described.

According to a further aspect of the invention, there is provided a blowing agent comprising a composition of the invention.

According to another aspect of the invention, there is provided a foamable composition comprising one or more components capable of forming foam and a composition of the invention.

Preferably, the one or more components capable of forming foam are selected from polyurethanes, thermoplastic polymers and resins, such as polystyrene, and epoxy resins.

According to a further aspect of the invention, there is provided a foam obtainable from the foamable composition of the invention.

Preferably the foam comprises a composition of the invention.

According to another aspect of the invention, there is provided a sprayable composition comprising a material to be sprayed and a propellant comprising a composition of the invention.

According to a further aspect of the invention, there is provided a method for cooling an article which comprises condensing a composition of the invention and thereafter evaporating said composition in the vicinity of the article to be cooled.

According to another aspect of the invention, there is provided a method for heating an article which comprises condensing a composition of the invention in the vicinity of the article to be heated and thereafter evaporating said composition.

According to a further aspect of the invention, there is provided a method for extracting a substance from biomass comprising contacting the biomass with a solvent comprising a composition of the invention, and separating the substance from the solvent.

According to another aspect of the invention, there is provided a method of cleaning an article comprising contacting the article with a solvent comprising a composition of the invention.

According to a further aspect of the invention, there is provided a method for extracting a material from an aqueous solution comprising contacting the aqueous solution with a solvent comprising a composition of the invention, and separating the material from the solvent.

According to another aspect of the invention, there is provided a method for extracting a material from a particulate solid matrix comprising contacting the particulate solid matrix with a solvent comprising a composition of the invention, and separating the material from the solvent.

According to a further aspect of the invention, there is provided a mechanical power generation device containing a composition of the invention.

Preferably, the mechanical power generation device is adapted to use a Rankine Cycle or modification thereof to generate work from heat.

According to another aspect of the invention, there is provided a method of retrofitting a heat transfer device comprising the step of removing an existing heat transfer fluid, and introducing a composition of the invention. Preferably, the heat transfer device is a refrigeration device or (a static) air conditioning system. Advantageously, the method further comprises the step of obtaining an allocation of greenhouse gas (e.g. carbon dioxide) emission credit.

In accordance with the retrofitting method described above, an existing heat transfer fluid can be fully removed from the heat transfer device before introducing a composition of the invention. An existing heat transfer fluid can also be partially removed from a heat transfer device, followed by introducing a composition of the invention.

Thus, the invention provides a method for preparing a composition and/or heat transfer device of the invention comprising introducing R-744, R-1234ze(E), and optional components such as a lubricant, a stabiliser or an additional flame retardant, into a heat transfer device containing an existing heat transfer fluid which contains R-32. Optionally, at least some of the R-32 is removed from the heat transfer device before introducing the R-744/R-1234ze(E) etc.

Of course, the compositions of the invention may also be prepared simply by mixing the R-744, R-32 and R-1234ze(E) (and optional components such as a lubricant, a stabiliser or an additional flame retardant) in the desired proportions. The compositions can then be added to a heat transfer device (or used in any other way as defined herein) that does not contain R-32 or any other existing heat transfer fluid, such as a device from which R-32 or any other existing heat transfer fluid have been removed.

In a further aspect of the invention, there is provided a method for reducing the environmental impact arising from operation of a product comprising an existing compound or composition, the method comprising replacing at least partially the existing compound or composition with a composition of the invention. Preferably, this method comprises the step of obtaining an allocation of greenhouse gas emission credit.

By environmental impact we include the generation and emission of greenhouse warming gases through operation of the product.

As mentioned above, this environmental impact can be considered as including not only those emissions of compounds or compositions having a significant environmental impact from leakage or other losses, but also including the emission of carbon dioxide arising from the energy consumed by the device over its working life. Such environmental impact may be quantified by the measure known as Total Equivalent Warming Impact (TEWI). This measure has been used in quantification of the environmental impact of certain stationary refrigeration and air conditioning equipment, including for example supermarket refrigeration systems (see, for example, http://en.wikipedia.org/wiki/Total_equivalent_warming_impact).

The environmental impact may further be considered as including the emissions of greenhouse gases arising from the synthesis and manufacture of the compounds or compositions. In this case the manufacturing emissions are added to the energy consumption and direct loss effects to yield the measure known as Life-Cycle Carbon Production (LCCP, see for example http://www.sae.org/events/aars/presentations/2007papasavva.pdf). The use of LCCP is common in assessing environmental impact of automotive air conditioning systems.

Emission credit(s) are awarded for reducing pollutant emissions that contribute to global warming and may, for example, be banked, traded or sold. They are conventionally expressed in the equivalent amount of carbon dioxide. Thus if the emission of 1 kg of R-134a is avoided then an emission credit of 1×1300=1300 kg CO₂ equivalent may be awarded.

In another embodiment of the invention, there is provided a method for generating greenhouse gas emission credit(s) comprising (i) replacing an existing compound or composition with a composition of the invention, wherein the composition of the invention has a lower GWP than the existing compound or composition; and (ii) obtaining greenhouse gas emission credit for said replacing step.

In a preferred embodiment, the use of the composition of the invention results in the equipment having a lower Total Equivalent Warming Impact, and/or a lower Life-Cycle Carbon Production than that which would be attained by use of the existing compound or composition.

These methods may be carried out on any suitable product, for example in the fields of air-conditioning, refrigeration (e.g. low and medium temperature refrigeration), heat transfer, blowing agents, aerosols or sprayable propellants, gaseous dielectrics, cryosurgery, veterinary procedures, dental procedures, fire extinguishing, flame suppression, solvents (e.g. carriers for flavorings and fragrances), cleaners, air horns, pellet guns, topical anesthetics, and expansion applications. Preferably, the field is air-conditioning or refrigeration.

Examples of suitable products include heat transfer devices, blowing agents, foamable compositions, sprayable compositions, solvents and mechanical power generation devices. In a preferred embodiment, the product is a heat transfer device, such as a refrigeration device or an air-conditioning unit.

The existing compound or composition has an environmental impact as measured by GWP and/or TEWI and/or LCCP that is higher than the composition of the invention which replaces it. The existing compound or composition may comprise a fluorocarbon compound, such as a perfluoro-, hydrofluoro-, chlorofluoro- or hydrochlorofluoro-carbon compound or it may comprise a fluorinated olefin

Preferably, the existing compound or composition is a heat transfer compound or composition such as a refrigerant. Examples of refrigerants that may be replaced include R-134a, R-152a, R-1234yf, R-410A, R-407A, R-407B, R-407C, R-507, R-22 and R-404A. The compositions of the invention are particularly suited as replacements for R-410A, R-407A, R-407B, R-407C, R-507, R-22 and R-404A.

Any amount of the existing compound or composition may be replaced so as to reduce the environmental impact. This may depend on the environmental impact of the existing compound or composition being replaced and the environmental impact of the replacement composition of the invention. Preferably, the existing compound or composition in the product is fully replaced by the composition of the invention.

The invention is illustrated by the following non-limiting examples.

### EXAMPLES

### Flammability

Flammability tests were carried out according to the method described in Appendix B of ASHRAE Standard 34-2010 (which is incorporated by reference herein) on composition of CO₂/R32/R1234ze(E). It was found that the compositions exhibit reduced flammability compared to R32.

### Fractionation Effects and Derivation of Fractionated Compositions

ASHRAE Standard 34 requires that for a mixed nonazeotropic refrigerant blend of defined nominal composition, with a specified manufacturing tolerance on the composition of each component, two related compositions are determined and tested. The flammability of the worse of these compositions is then used to classify the refrigerant's nominal composition.

The first composition to be considered is the “Worst Case Formulation” (WCF). This is the most flammable composition, which could result if the blend were made inside its manufacturing tolerance. Refrigerant blends are typically produced with a manufacturing tolerance of ±1% on minor components and ±2% on the major component. In the case of these ternary compositions of CO₂/R32/R1234ze(E), R32 is the most flammable species, R1234ze(E) is intermediate in behaviour, being non-flammable at ambient temperature but flammable at elevated temperatures, and CO₂ is wholly non-flammable. The WCF for a defined refrigerant composition with its associated manufacturing tolerance is then the composition having the maximal permitted R-32 and R-1234ze(E) content and the lowest permitted CO₂ content.

The second composition to be assessed arises from consideration of potential composition changes during handling and use, which are caused as a consequence of differing vapour and liquid phase compositions in situations where both phases are present and at equilibrium. Standard 34 requires the consideration of the effect of partial leakage of either vapour or liquid from a cylinder or system to be considered over a range of temperatures, considering removal of both vapour and liquid phases to identify the worst composition that can occur in either phase. The resulting compositions derived as a result of this exercise are assessed and the composition having the highest proportion of flammable material is termed the “Worst Case Formulation for Flammability” or WCFF.

A composition of formulation CO₂/R32/R1234ze(E) in the nominal proportions 6%160%134% by weight (hereinafter “Blend 1”) with tolerances ±1%, ±1%, ±2% was studied. The WCF for this formulation (“Blend 1-WCF”) was taken as CO₂/R32/R1234ze(E) 5%161%132% by weight.

It was found that for this nominal composition the WCFF arose from removal of vapour from a cylinder at a temperature of 40° C., with the cylinder initially 90% liquid filled. The WCFF was determined as being that composition having the highest concentration of R32 in the vapour phase. This WCFF composition (“Blend 1-WCFF”) was found to be CO₂/R32/R1234ze(E) in the proportions 1.1%/78.5%/20.4% by weight, which occurred part-way through removal of the cylinder contents as vapour.

### Testing Results

The flammability of the WCF and WCFF compositions identified above was assessed at atmospheric pressure using the 12 litre flask method defined in ASHRAE Standard 34 to determine the lower and upper flammable limits for the blends. The test temperatures used were 23° C. and 60° C. The humidity in the flask was controlled to be equivalent to 50% RH at 25° C. The following table shows the results:

| | LFL (% v/v) | | UFL (% v/v) | |
|---|---|---|---|---|
| | @ 23° C. | @ 60° C. | @ 23° C. | @ 60° C. |
| CO₂/R32/R1234ze(E) | 13 | 13 | 22 | 24 |
| 5/61/34% w/w | | | | |
| (Blend 1-WCF) | | | | |
| CO₂/R32/R1234ze(E) | 13 | | 24 | |
| 1.1/78.5/20.4% w/w | | | | |
| (Blend1-WCFF) | | | | |

The lower flammable limit (LFL) and upper flammable limit (UFL) of R32 are known to be 14%-31% by volume in air, in other words a flammable range (difference in flammable limits) of 17% v/v in air exists for this fluid. The flammable limits of R32 are similar at both 23 C and 60 C.

The flammable range of both the WCF and WCFF as tested is of the order of 9-12% v/v, in other words it is reduced compared to R32, thereby reducing the potential size of any zone of flammability around a leak point in the event of a leak.

### Comparative Calculation

Le Chatelier's law of flammable limit determination for mixed fuels can be used to estimate the flammability of gas mixtures. This was done for the Blend 1-WCF and Blend 1-WCFF compositions at 23 C. The flammable limits of R1234ze(E) in air were taken as equivalent to those of its isomer R-1234yf (6.2%-13% v/v) for the purposes of this estimation since on its own R1234ze(E) does not exhibit flammability at 23° C. but it is known to show similar flammability limits to R1234yf at elevated temperature.

The estimated flammability limits are tabulated below:

| | LFL (% v/v) | UFL (% v/v) | Range (% v/v) |
|---|---|---|---|
| Blend1-WCF | 11.2% | 24% | 12.8% |
| Blend1-WCFF | 12.4% | 27% | 14.6% |

It is seen that the measured flammability limits and flammable range for the blends are consistently lower than those that could be expected using Le Chatelier's law. Furthermore the lower flammable limit values, which are the normal measure of hazard, are elevated in both cases compared to the estimated value. In summary, the compositions of the invention are surprisingly less flammable than predicted by Le Chatelier estimation.

### Refrigeration Performance

The thermodynamic properties of R-1234ze(E) were established by measurement of liquid and vapour densities, critical point, saturated liquid vapour pressure, liquid and vapour enthalpies. The ideal gas heat capacity was estimated using Hyperchem molecular modelling software. These data were then used to generate parameters for the Helmholtz energy equation of state as implemented in NIST REFPROP v8.0. The vapour liquid equilibrium (VLE) behaviour of the two binary mixtures of carbon dioxide and R-32 with R-1234ze(E) was measured over the full composition range and at temperatures from 40 to 60° C. in static and dynamic VLE apparatus. The resulting pressure/temperature/composition data were regressed to the REFPROP model, using the standard fluid models for R-744 and R-32 included in the software. Literature data for the VLE behaviour of R-32 and R-744 (Adams and Stein op cit, and Rivollet et al Fluid Phase Equilibria 218(1) 2004 pp 95-101, which is incorporated by reference herein) were similarly regressed into the REFPROP model. This combination of VLE data enabled accurate estimation of the thermodynamic properties of the ternary R-744/R-32/R-1234ze(E) system.

The performance of the fluids of the invention for air conditioning applications was then assessed in comparison with R-410A. The cycle conditions used are listed in Table 1 and Table 2. The performance of R-32 was estimated as a comparative example using the same cycle calculation methods.

TABLE 1
cycle conditions for moderate ambient air temperature

| Reference refrigerant | | R410A |
|---|---|---|
| Cooling duty | kW | 10.56 |
| Mean condenser temperature | ° C. | 40.0 |
| Mean evaporator temperature | ° C. | 5.0 |
| Condenser subcooling | K | 5.0 |
| Evaporator superheat | K | 5.0 |
| Evaporator pressure drop | bar | 0.2 |
| Suction line pressure drop | bar | 0.10 |
| Condenser pressure drop | bar | 0.2 |
| Compressor suction temperature | ° C. | 25.0 |
| Isentropic efficiency | | 70% |

TABLE 2
cycle conditions for high ambient air temperature

| Reference refrigerant | | R410A |
|---|---|---|
| Cooling duty | kW | 10.56 |
| Mean condenser temperature | ° C. | 60 |
| Mean evaporator temperature | ° C. | 5.0 |
| Condenser subcooling | K | 5.0 |
| Evaporator superheat | K | 5.0 |
| Evaporator pressure drop | bar | 0.2 |
| Suction line pressure drop | bar | 0.10 |
| Condenser pressure drop | bar | 0.2 |
| Compressor suction temperature | ° C. | 25.0 |
| Isentropic efficiency | | 70% |

The pressure drops for the fluids in the invention were calculated by scaling from the stated cooling loads and pressure drops for the reference refrigerant (R-410A), under the assumption of equal cooling capacity and equal heat exchanger flow resistance.

Using the above model, the performance data for the references R-410A and R-32 at medium ambient air temperature and at high ambient air temperature are shown below.

### Medium Ambient Air Temperature

| Reference Refrigerant | | R-410A | R-32 |
|---|---|---|---|
| COP | | 3.97 | 4.11 |
| COP relative to Reference | | 100.0% | 103.5% |
| Volumetric capacity | kJ/m³ | 5286 | 5800 |
| Capacity relative to Reference | | 100.0% | 109.7% |
| Critical temperature | ° C. | 71.4 | 78.1 |
| Critical pressure | bar | 49.0 | 57.8 |
| Refrigeration effect | kJ/kg | 171.8 | 257.5 |
| Pressure ratio | | 2.66 | 2.64 |
| Compressor discharge temperature | ° C. | 87.3 | 104.9 |
| Evaporator inlet pressure | bar | 9.44 | 9.58 |
| Condenser inlet pressure | bar | 24.3 | 24.8 |
| Evaporator inlet temperature | ° C. | 5.3 | 5.2 |
| Evaporator dewpoint | ° C. | 4.7 | 4.8 |
| Evaporator exit gas temperature | ° C. | 9.7 | 9.8 |
| Evaporator glide (out-in) | K | −0.6 | −0.4 |
| Compressor suction pressure | bar | 9.14 | 9.39 |
| Compressor discharge pressure | bar | 24.3 | 24.8 |
| Condenser dew point | ° C. | 40.2 | 40.1 |
| Condenser bubble point | ° C. | 39.8 | 39.9 |
| Condenser exit liquid temperature | ° C. | 34.8 | 34.9 |
| Condenser glide (in-out) | K | 0.5 | 0.2 |

### High Ambient Air Temperature

| Reference Refrigerant | | R-410A | R-32 |
|---|---|---|---|
| COP (heating) | | 2.07 | 2.24 |
| COP (heating) relative to Reference | | 100.0% | 108.5% |
| Volumetric capacity | kJ/m³ | 4110 | 4837 |
| Capacity relative to Reference | | 100.0% | 117.7% |
| Critical temperature (° C.) | | 71.4 | 78.1 |
| Critical pressure (bar) | | 49.0 | 57.8 |
| Refrigeration effect | kJ/kg | 133.6 | 214.4 |
| Pressure ratio | | 4.21 | 4.19 |
| Compressor discharge temperature | ° C. | 118.7 | 145.5 |
| Evaporator inlet pressure | bar | 9.44 | 9.57 |
| Condenser inlet pressure | bar | 38.5 | 39.4 |
| Evaporator inlet temperature | ° C. | 5.3 | 5.2 |
| Evaporator dewpoint | ° C. | 4.7 | 4.8 |
| Evaporator exit gas temperature | ° C. | 9.7 | 9.8 |
| Evaporator glide (out-in) | K | −0.6 | −0.4 |
| Compressor suction pressure | bar | 9.14 | 9.41 |
| Compressor discharge pressure | bar | 38.5 | 39.4 |
| Condenser dew point | ° C. | 60.2 | 60.1 |
| Condenser bubble point | ° C. | 59.8 | 59.9 |
| Condenser exit liquid temperature | ° C. | 54.8 | 54.9 |
| Condenser glide (in-out) | K | 0.3 | 0.1 |

The generated performance data for selected compositions of the invention is set out in Tables 3 to 14. The tables show key parameters of the air conditioning cycle, including operating pressures, volumetric cooling capacity, energy efficiency (expressed as coefficient of performance for cooling COP) compressor discharge temperature and pressure drops in pipework. The volumetric cooling capacity of a refrigerant is a measure of the amount of cooling which can be obtained for a given size of compressor operating at fixed speed. The coefficient of performance (COP) is the ratio of the amount of heat energy removed in the evaporator of the air conditioning cycle to the amount of work consumed by the compressor.

The data demonstrates that the compositions of the invention have been found to offer cooling capacities that are within about 95-115% of R-410A values whilst maintaining operating pressure levels close to those of R-410A. The energy efficiency is consistently higher than that of R-410A and comparable or higher than that of R-32. The compressor discharge temperature is maintained at values significantly lower than that of R-32 and the temperature glide in evaporator and condenser is lower than about 10 K.

Simulation of performance as a heat pump fluid shows similar trends for the fluids of the invention in relative capacity, COP and operating pressures and temperatures when compared with that of R-410A.

The fluids of the invention generally offer operating pressures that are comparable or lower to those of R-32 or R-410A, and operate over similar compression ratios, thereby maintaining compressor efficiencies close to the values typical of R-410A units.

For applications to combined air conditioner/heat pump duty lower glide fluids of the invention are preferred. This is because such units must use the indoor and outdoor heat exchangers to transfer heat in or out of the building as load demands, and so the thermal profiles in the exchangers must tolerate refrigerant either evaporating or condensing.

For dedicated air conditioners or heat pump units then higher glide may be tolerated as the heat exchanger geometries may then be optimised to allow exploitation of the temperature glide in a Lorentz cycle configuration.

It should be noted in passing that the utility of fluids of the invention is not limited to residential systems. Indeed these fluids can be used in or commercial air-conditioning and heating equipment. Currently the main fluids used in such stationary equipment are R-410A (having a GWP of 2100) or R22 (having a GWP of 1800 and an ozone depletion potential of 0.05). The use of the fluids of the invention in such equipment offers the ability to realise similar utility but with fluids having no ozone depletion potential and significantly reduced GWP compared to R410A.

The fluids of the invention may also find utility in transport air conditioning systems for example trains, commercial vehicles, buses and the like.

It is further found for all the fluids of the invention that the critical temperature typically is about 70° C. or higher. This is particularly significant for stationary heat pumping applications where R-410A is currently used. The fundamental thermodynamic efficiency of a vapour compression process is affected by proximity of the critical temperature to the condensing temperature. R-410A has gained acceptance and can be considered an acceptable fluid for this application; its critical temperature is 71° C. It has unexpectedly been found that significant quantities of CO₂ (critical temperature 31° C.) can be incorporated in fluids of the invention to yield mixtures having similar or higher critical temperature to R-410A. Preferred compositions of the invention therefore have critical temperatures of about 70° C. or higher.

It is evident by inspection of the tables that fluids of the invention have been discovered having comparable heating capacities and energy efficiencies to R-410A, allowing adaptation of existing R-410A technology to use the fluids of the invention if so desired.

Compositions outside those tabulated in the performance but which exhibit the following combination of properties are also claimed as part of the invention:
Critical temperature equal or higher to that of R-410A
Condensing pressure within about 1 bar of R-410A at the same mean condensing temperature
Compressor discharge temperature lower than R-32 when operating between the same mean evaporating and condensing temperatures
Temperature glide of less than about 15K for condenser and evaporator when subjected to a vapour compression cycle as illustrated in the tables.

The invention is defined by the claims.

TABLE 3
Theoretical Performance Data of Selected R-744/R-32/R-1234ze(E) blends
containing 4% R-744 and 50-80% R-32 - Medium Ambient Air Performance

| | | Composition CO₂/R-32/R-1234ze(E) | | | | | | | |
|---|---|---|---|---|---|---|---|---|---|
| | | % by weight | | | | | | | |
| | | 4/50/46 | 4/55/41 | 4/60/36 | 4/65/31 | 4/67/29 | 4/70/26 | 4/75/21 | 4/80/16 |
| COP | | 4.22 | 4.20 | 4.18 | 4.17 | 4.16 | 4.15 | 4.14 | 4.13 |
| COP relative to Reference | | 106.4% | 105.9% | 105.5% | 105.1% | 104.9% | 104.7% | 104.4% | 104.0% |
| Volumetric capacity | kJ/m³ | 4718 | 4904 | 5084 | 5259 | 5326 | 5427 | 5588 | 5744 |
| Capacity relative to Reference | | 89.2% | 92.8% | 96.2% | 99.5% | 100.8% | 102.7% | 105.7% | 108.7% |
| Critical temperature (° C.) | | 84.5 | 83.4 | 82.3 | 81.4 | 81.0 | 80.5 | 79.6 | 78.8 |
| Critical pressure (bar) | | 54.1 | 54.9 | 55.7 | 56.4 | 56.7 | 57.0 | 57.6 | 58.1 |
| Refrigeration effect | kJ/kg | 213.2 | 217.7 | 222.2 | 226.8 | 228.6 | 231.4 | 236.1 | 240.9 |
| Pressure ratio | | 2.84 | 2.81 | 2.79 | 2.76 | 2.75 | 2.74 | 2.71 | 2.69 |
| Compressor discharge temperature | ° C. | 91.5 | 93.0 | 94.6 | 96.1 | 96.7 | 97.6 | 99.1 | 100.6 |
| Evaporator inlet pressure | bar | 7.41 | 7.76 | 8.10 | 8.43 | 8.56 | 8.76 | 9.07 | 9.38 |
| Condenser inlet pressure | bar | 20.3 | 21.1 | 21.9 | 22.6 | 22.9 | 23.4 | 24.1 | 24.7 |
| Evaporator inlet temperature | ° C. | 0.5 | 0.9 | 1.4 | 1.8 | 2.0 | 2.3 | 2.7 | 3.1 |
| Evaporator dewpoint | ° C. | 9.5 | 9.1 | 8.6 | 8.2 | 8.0 | 7.7 | 7.3 | 6.9 |
| Evaporator exit gas temperature | ° C. | 14.5 | 14.1 | 13.6 | 13.2 | 13.0 | 12.7 | 12.3 | 11.9 |
| Evaporator glide (out-in) | K | 9.0 | 8.1 | 7.2 | 6.3 | 5.9 | 5.4 | 4.5 | 3.7 |
| Compressor suction pressure | bar | 7.14 | 7.50 | 7.86 | 8.20 | 8.34 | 8.54 | 8.87 | 9.18 |
| Compressor discharge pressure | bar | 20.3 | 21.1 | 21.9 | 22.6 | 22.9 | 23.4 | 24.1 | 24.7 |
| Condenser dew point | ° C. | 45.4 | 44.8 | 44.2 | 43.7 | 43.5 | 43.2 | 42.7 | 42.3 |
| Condenser bubble point | ° C. | 34.6 | 35.2 | 35.8 | 36.3 | 36.5 | 36.8 | 37.3 | 37.7 |
| Condenser exit liquid temperature | ° C. | 29.6 | 30.2 | 30.8 | 31.3 | 31.5 | 31.8 | 32.3 | 32.7 |
| Condenser glide (in-out) | K | 10.7 | 9.6 | 8.4 | 7.4 | 7.0 | 6.4 | 5.5 | 4.6 |

TABLE 4
Theoretical Performance Data of Selected R-744/R-32/R-1234ze(E) blends
containing 5% R-744 and 50-80% R-32 - Medium Ambient Air Performance

| | | Composition CO₂/R-32/R-1234ze(E) | | | | | | | |
|---|---|---|---|---|---|---|---|---|---|
| | | % by weight | | | | | | | |
| | | 5/50/45 | 5/55/40 | 5/60/35 | 5/65/30 | 5/67/28 | 5/70/25 | 5/75/20 | 5/80/15 |
| COP | | 4.22 | 4.20 | 4.18 | 4.16 | 4.16 | 4.15 | 4.13 | 4.12 |
| COP relative to Reference | | 106.3% | 105.8% | 105.4% | 105.0% | 104.8% | 104.6% | 104.2% | 103.9% |
| Volumetric capacity | kJ/m³ | 4855 | 5040 | 5219 | 5392 | 5459 | 5558 | 5719 | 5873 |
| Capacity relative to Reference | | 91.8% | 95.3% | 98.7% | 102.0% | 103.3% | 105.1% | 108.2% | 111.1% |
| Critical temperature | ° C. | 83.7 | 82.6 | 81.6 | 80.7 | 80.3 | 79.8 | 79.0 | 78.2 |
| Critical pressure | bar | 54.5 | 55.4 | 56.1 | 56.8 | 57.1 | 57.5 | 58.1 | 58.6 |
| Refrigeration effect | kJ/kg | 214.4 | 218.8 | 223.3 | 227.8 | 229.6 | 232.4 | 237.0 | 241.7 |
| Pressure ratio | | 2.84 | 2.81 | 2.78 | 2.75 | 2.74 | 2.73 | 2.71 | 2.69 |
| Compressor discharge temperature | ° C. | 92.0 | 93.5 | 95.0 | 96.5 | 97.1 | 98.0 | 99.5 | 101.0 |
| Evaporator inlet pressure | bar | 7.62 | 7.97 | 8.32 | 8.65 | 8.79 | 8.98 | 9.30 | 9.60 |
| Condenser inlet pressure | bar | 20.9 | 21.7 | 22.5 | 23.2 | 23.5 | 23.9 | 24.6 | 25.3 |
| Evaporator inlet temperature | ° C. | 0.2 | 0.7 | 1.2 | 1.6 | 1.8 | 2.1 | 2.6 | 3.0 |
| Evaporator dewpoint | ° C. | 9.8 | 9.3 | 8.8 | 8.4 | 8.2 | 7.9 | 7.4 | 7.0 |
| Evaporator exit gas temperature | ° C. | 14.8 | 14.3 | 13.8 | 13.4 | 13.2 | 12.9 | 12.4 | 12.0 |
| Evaporator glide (out-in) | K | 9.6 | 8.6 | 7.7 | 6.7 | 6.3 | 5.8 | 4.9 | 4.1 |
| Compressor suction pressure | bar | 7.36 | 7.73 | 8.08 | 8.43 | 8.57 | 8.77 | 9.10 | 9.41 |
| Compressor discharge pressure | bar | 20.9 | 21.7 | 22.5 | 23.2 | 23.5 | 23.9 | 24.6 | 25.3 |
| Condenser dew point | ° C. | 45.6 | 45.0 | 44.5 | 43.9 | 43.7 | 43.4 | 42.9 | 42.5 |
| Condenser bubble point | ° C. | 34.4 | 35.0 | 35.5 | 36.1 | 36.3 | 36.6 | 37.1 | 37.5 |
| Condenser exit liquid temperature | ° C. | 29.4 | 30.0 | 30.5 | 31.1 | 31.3 | 31.6 | 32.1 | 32.5 |
| Condenser glide (in-out) | K | 11.3 | 10.1 | 8.9 | 7.8 | 7.4 | 6.8 | 5.9 | 5.0 |

TABLE 5
Theoretical Performance Data of Selected R-744/R-32/R-1234ze(E) blends
containing 6% R-744 and 50-75% R-32 - Medium Ambient Air Performance

| | | Composition CO₂/R-32/R-1234ze(E) | | | | | | |
|---|---|---|---|---|---|---|---|---|
| | | % by weight | | | | | | |
| | | 6/50/44 | 6/55/39 | 6/60/34 | 6/65/29 | 6/67/27 | 6/70/24 | 6/75/19 |
| COP | | 4.21 | 4.19 | 4.17 | 4.16 | 4.15 | 4.14 | 4.13 |
| COP relative to Reference | | 106.2% | 105.7% | 105.3% | 104.8% | 104.7% | 104.4% | 104.1% |
| Volumetric capacity | kJ/m³ | 4991 | 5175 | 5353 | 5524 | 5591 | 5690 | 5850 |
| Capacity relative to Reference | | 94.4% | 97.9% | 101.3% | 104.5% | 105.8% | 107.6% | 110.7% |
| Critical temperature | ° C. | 82.8 | 81.8 | 80.9 | 80.0 | 79.6 | 79.2 | 78.4 |
| Critical pressure | bar | 54.9 | 55.8 | 56.6 | 57.3 | 57.6 | 57.9 | 58.5 |
| Refrigeration effect | kJ/kg | 215.5 | 219.9 | 224.3 | 228.8 | 230.5 | 233.3 | 237.9 |
| Pressure ratio | | 2.83 | 2.80 | 2.77 | 2.75 | 2.74 | 2.72 | 2.70 |
| Compressor discharge temperature | ° C. | 92.5 | 94.0 | 95.5 | 97.0 | 97.6 | 98.5 | 99.9 |
| Evaporator inlet pressure | bar | 7.84 | 8.19 | 8.54 | 8.88 | 9.01 | 9.21 | 9.52 |
| Condenser inlet pressure | bar | 21.5 | 22.3 | 23.1 | 23.8 | 24.1 | 24.5 | 25.2 |
| Evaporator inlet temperature | ° C. | 0.0 | 0.5 | 1.0 | 1.5 | 1.6 | 1.9 | 2.4 |
| Evaporator dewpoint | ° C. | 10.0 | 9.5 | 9.0 | 8.5 | 8.4 | 8.1 | 7.6 |
| Evaporator exit gas temperature | ° C. | 15.0 | 14.5 | 14.0 | 13.5 | 13.4 | 13.1 | 12.6 |
| Evaporator glide (out-in) | K | 10.1 | 9.1 | 8.1 | 7.1 | 6.7 | 6.1 | 5.2 |
| Compressor suction pressure | bar | 7.58 | 7.95 | 8.31 | 8.66 | 8.80 | 9.00 | 9.33 |
| Compressor discharge pressure | bar | 21.5 | 22.3 | 23.1 | 23.8 | 24.1 | 24.5 | 25.2 |
| Condenser dew point | ° C. | 45.9 | 45.3 | 44.7 | 44.1 | 43.9 | 43.6 | 43.1 |
| Condenser bubble point | ° C. | 34.1 | 34.7 | 35.3 | 35.9 | 36.1 | 36.4 | 36.9 |
| Condenser exit liquid temperature | ° C. | 29.1 | 29.7 | 30.3 | 30.9 | 31.1 | 31.4 | 31.9 |
| Condenser glide (in-out) | K | 11.8 | 10.5 | 9.4 | 8.3 | 7.8 | 7.2 | 6.3 |

TABLE 6
Theoretical Performance Data of Selected R-744/R-32/R-1234ze(E) blends
containing 7% R-744 and 50-70% R-32 - Medium Ambient Air Performance

| | | Composition CO₂/R-32/R-1234ze(E) | | | | | |
|---|---|---|---|---|---|---|---|
| | | % by weight | | | | | |
| | | 7/50/43 | 7/55/38 | 7/59/34 | 7/60/33 | 7/65/28 | 7/70/23 |
| COP | | 4.19 | 4.17 | 4.16 | 4.16 | 4.14 | 4.12 |
| COP relative to Reference | | 106.2% | 105.7% | 105.3% | 105.2% | 104.8% | 104.4% |
| Volumetric capacity | kJ/m3 | 5114 | 5297 | 5439 | 5474 | 5646 | 5811 |
| Capacity relative to Reference | | 97.0% | 100.5% | 103.2% | 103.9% | 107.1% | 110.2% |
| Critical temperature | ° C. | 82.0 | 81.1 | 80.3 | 80.2 | 79.3 | 78.5 |
| Critical pressure | bar | 55.3 | 56.2 | 56.9 | 57.0 | 57.7 | 58.4 |
| Refrigeration effect | kJ/kg | 216.7 | 221.0 | 224.4 | 225.3 | 229.7 | 234.2 |
| Pressure ratio | | 2.83 | 2.80 | 2.78 | 2.77 | 2.75 | 2.73 |
| Compressor discharge temperature | ° C. | 93.2 | 94.7 | 95.9 | 96.2 | 97.6 | 99.1 |
| Evaporator inlet pressure | bar | 8.08 | 8.43 | 8.71 | 8.78 | 9.12 | 9.45 |
| Condenser inlet pressure | bar | 22.1 | 22.9 | 23.5 | 23.7 | 24.4 | 25.1 |
| Evaporator inlet temperature | ° C. | −0.2 | 0.3 | 0.7 | 0.8 | 1.3 | 1.8 |
| Evaporator dewpoint | ° C. | 10.2 | 9.7 | 9.3 | 9.2 | 8.7 | 8.2 |
| Evaporator exit gas temperature | ° C. | 15.2 | 14.7 | 14.3 | 14.2 | 13.7 | 13.2 |
| Evaporator glide (out-in) | K | 10.4 | 9.4 | 8.5 | 8.3 | 7.3 | 6.4 |
| Compressor suction pressure | bar | 7.79 | 8.16 | 8.45 | 8.53 | 8.88 | 9.22 |
| Compressor discharge pressure | bar | 22.1 | 22.9 | 23.5 | 23.7 | 24.4 | 25.1 |
| Condenser dew point | ° C. | 46.2 | 45.5 | 45.0 | 44.9 | 44.3 | 43.8 |
| Condenser bubble point | ° C. | 33.8 | 34.5 | 35.0 | 35.1 | 35.7 | 36.2 |
| Condenser exit liquid temperature | ° C. | 28.8 | 29.5 | 30.0 | 30.1 | 30.7 | 31.2 |
| Condenser glide (in-out) | K | 12.3 | 11.0 | 10.1 | 9.8 | 8.7 | 7.6 |

TABLE 7
Theoretical Performance Data of Selected R-744/R-32/R-1234ze(E) blends
containing 8% R-744 and 50-70% R-32 - Medium Ambient Air Performance

| | | Composition CO₂/R-32/R-1234ze(E) | | | | | |
|---|---|---|---|---|---|---|---|
| | | % by weight | | | | | |
| | | 8/50/42 | 8/55/37 | 8/60/32 | 8/65/27 | 8/67/25 | 8/70/22 |
| COP | | 4.20 | 4.18 | 4.16 | 4.15 | 4.14 | 4.13 |
| COP relative to Reference | | 106.0% | 105.5% | 105.0% | 104.5% | 104.4% | 104.1% |
| Volumetric capacity | kJ/m³ | 5264 | 5445 | 5620 | 5789 | 5855 | 5953 |
| Capacity relative to Reference | | 99.6% | 103.0% | 106.3% | 109.5% | 110.8% | 112.6% |
| Critical temperature | ° C. | 81.2 | 80.3 | 79.5 | 78.7 | 78.3 | 77.9 |
| Critical pressure | bar | 55.8 | 56.6 | 57.4 | 58.2 | 58.4 | 58.8 |
| Refrigeration effect | kJ/kg | 217.6 | 221.9 | 226.2 | 230.5 | 232.3 | 234.9 |
| Pressure ratio | | 2.81 | 2.79 | 2.76 | 2.74 | 2.73 | 2.71 |
| Compressor discharge temperature | ° C. | 93.4 | 94.9 | 96.4 | 97.9 | 98.4 | 99.3 |
| Evaporator inlet pressure | bar | 8.28 | 8.64 | 8.99 | 9.33 | 9.47 | 9.67 |
| Condenser inlet pressure | bar | 22.6 | 23.4 | 24.2 | 25.0 | 25.3 | 25.7 |
| Evaporator inlet temperature | ° C. | −0.5 | 0.1 | 0.6 | 1.1 | 1.3 | 1.6 |
| Evaporator dewpoint | ° C. | 10.5 | 9.9 | 9.4 | 8.9 | 8.7 | 8.4 |
| Evaporator exit gas temperature | ° C. | 15.5 | 14.9 | 14.4 | 13.9 | 13.7 | 13.4 |
| Evaporator glide (out-in) | K | 11.0 | 9.9 | 8.8 | 7.8 | 7.4 | 6.8 |
| Compressor suction pressure | bar | 8.04 | 8.41 | 8.78 | 9.13 | 9.27 | 9.47 |
| Compressor discharge pressure | bar | 22.6 | 23.4 | 24.2 | 25.0 | 25.3 | 25.7 |
| Condenser dew point | ° C. | 46.3 | 45.7 | 45.1 | 44.5 | 44.3 | 44.0 |
| Condenser bubble point | ° C. | 33.7 | 34.3 | 34.9 | 35.5 | 35.7 | 36.0 |
| Condenser exit liquid temperature | ° C. | 28.7 | 29.3 | 29.9 | 30.5 | 30.7 | 31.0 |
| Condenser glide (in-out) | K | 12.7 | 11.4 | 10.1 | 9.0 | 8.5 | 7.9 |

TABLE 8
Theoretical Performance Data of Selected R-744/R-32/R-1234ze(E) blends containing 10 and
12% R-744 and 50-60% R-32 and 12% R-744 and 50-60% R-32 - Medium Ambient Air Performance

| | | Composition CO₂/R-32/R-1234ze(E) | | | | | |
|---|---|---|---|---|---|---|---|
| | | % by weight | | | | | |
| | | 10/50/40 | 10/55/35 | 10/60/30 | 12/50/38 | 12/55/33 | 12/60/28 |
| COP | | 4.19 | 4.17 | 4.15 | 4.18 | 4.16 | 4.14 |
| COP relative to Reference | | 105.8% | 105.2% | 104.7% | 105.5% | 104.9% | 104.3% |
| Volumetric capacity | kJ/m³ | 5536 | 5714 | 5886 | 5805 | 5981 | 6151 |
| Capacity relative to Reference | | 104.7% | 108.1% | 111.3% | 109.8% | 113.1% | 116.4% |
| Critical temperature | ° C. | 79.7 | 78.9 | 78.1 | 78.2 | 77.5 | 76.8 |
| Critical pressure | bar | 56.6 | 57.5 | 58.3 | 57.4 | 58.4 | 59.2 |
| Refrigeration effect | kJ/kg | 219.5 | 223.6 | 227.8 | 221.2 | 225.2 | 229.3 |
| Pressure ratio | | 2.80 | 2.77 | 2.75 | 2.78 | 2.76 | 2.73 |
| Compressor discharge temperature | ° C. | 94.3 | 95.8 | 97.2 | 95.1 | 96.6 | 98.0 |
| Evaporator inlet pressure | bar | 8.73 | 9.10 | 9.46 | 9.20 | 9.57 | 9.93 |
| Condenser inlet pressure | bar | 23.8 | 24.6 | 25.4 | 25.0 | 25.8 | 26.6 |
| Evaporator inlet temperature | ° C. | −0.9 | −0.3 | 0.3 | −1.2 | −0.6 | 0.0 |
| Evaporator dewpoint | ° C. | 10.9 | 10.3 | 9.7 | 11.2 | 10.6 | 10.0 |
| Evaporator exit gas temperature | ° C. | 15.9 | 15.3 | 14.7 | 16.2 | 15.6 | 15.0 |
| Evaporator glide (out-in) | K | 11.8 | 10.6 | 9.5 | 12.4 | 11.2 | 10.0 |
| Compressor suction pressure | bar | 8.51 | 8.89 | 9.25 | 8.99 | 9.37 | 9.74 |
| Compressor discharge pressure | bar | 23.8 | 24.6 | 25.4 | 25.0 | 25.8 | 26.6 |
| Condenser dew point | ° C. | 46.7 | 46.0 | 45.4 | 47.0 | 46.3 | 45.6 |
| Condenser bubble point | ° C. | 33.3 | 34.0 | 34.6 | 33.0 | 33.7 | 34.4 |
| Condenser exit liquid temperature | ° C. | 28.3 | 29.0 | 29.6 | 28.0 | 28.7 | 29.4 |
| Condenser glide (in-out) | K | 13.4 | 12.0 | 10.7 | 13.9 | 12.5 | 11.2 |

TABLE 9
Theoretical Performance Data of Selected R-744/R-32/R-1234ze(E) blends
containing 4% R-744 and 50-80% R-32 - High Ambient Air Performance

| | | Composition CO₂/R-32/R-1234ze(E) | | | | | | | |
|---|---|---|---|---|---|---|---|---|---|
| | | % by weight | | | | | | | |
| | | 4/50/46 | 4/55/41 | 4/60/36 | 4/65/31 | 4/67/29 | 4/70/26 | 4/75/21 | 4/80/16 |
| COP | | 2.30 | 2.29 | 2.27 | 2.26 | 2.26 | 2.25 | 2.24 | 2.23 |
| COP relative to Reference (R410A) | | 111.2% | 110.6% | 110.1% | 109.5% | 109.3% | 109.0% | 108.6% | 108.1% |
| Volumetric capacity | kJ/m³ | 3754 | 3920 | 4081 | 4236 | 4296 | 4386 | 4530 | 4670 |
| Capacity relative to Reference (R410A) | | 91.3% | 95.4% | 99.3% | 103.1% | 104.5% | 106.7% | 110.2% | 113.6% |
| Critical temperature (° C.) | | 84.5 | 83.4 | 82.3 | 81.4 | 81.0 | 80.5 | 79.6 | 78.8 |
| Critical pressure (bar) | | 54.1 | 54.9 | 55.7 | 56.4 | 56.7 | 57.0 | 57.6 | 58.1 |
| Refrigeration effect | kJ/kg | 174.9 | 178.7 | 182.6 | 186.5 | 188.1 | 190.5 | 194.5 | 198.6 |
| Pressure ratio | | 4.65 | 4.58 | 4.52 | 4.46 | 4.44 | 4.40 | 4.36 | 4.31 |
| Compressor discharge temperature | ° C. | 124.9 | 127.3 | 129.7 | 132.1 | 133.0 | 134.4 | 136.7 | 139.1 |
| Evaporator inlet pressure | bar | 7.20 | 7.56 | 7.92 | 8.26 | 8.40 | 8.60 | 8.93 | 9.24 |
| Condenser inlet pressure | bar | 32.3 | 33.5 | 34.8 | 35.9 | 36.4 | 37.0 | 38.1 | 39.1 |
| Evaporator inlet temperature | ° C. | 1.3 | 1.7 | 2.0 | 2.4 | 2.6 | 2.8 | 3.2 | 3.6 |
| Evaporator dewpoint | ° C. | 8.7 | 8.3 | 8.0 | 7.6 | 7.4 | 7.2 | 6.8 | 6.4 |
| Evaporator exit gas temperature | ° C. | 13.7 | 13.3 | 13.0 | 12.6 | 12.4 | 12.2 | 11.8 | 11.4 |
| Evaporator glide (out-in) | K | 7.4 | 6.7 | 5.9 | 5.1 | 4.8 | 4.4 | 3.6 | 2.9 |
| Compressor suction pressure | bar | 6.95 | 7.33 | 7.70 | 8.06 | 8.20 | 8.41 | 8.74 | 9.07 |
| Compressor discharge pressure | bar | 32.3 | 33.5 | 34.8 | 35.9 | 36.4 | 37.0 | 38.1 | 39.1 |
| Condenser dew point | ° C. | 64.2 | 63.7 | 63.3 | 62.8 | 62.6 | 62.4 | 62.0 | 61.7 |
| Condenser bubble point | ° C. | 55.8 | 56.3 | 56.7 | 57.2 | 57.4 | 57.6 | 58.0 | 58.3 |
| Condenser exit liquid temperature | ° C. | 50.8 | 51.3 | 51.7 | 52.2 | 52.4 | 52.6 | 53.0 | 53.3 |
| Condenser glide (in-out) | K | 8.5 | 7.5 | 6.5 | 5.6 | 5.3 | 4.8 | 4.0 | 3.4 |

TABLE 10
Theoretical Performance Data of Selected R-744/R-32/R-1234ze(E) blends
containing 5% R-744 and 50-80% R-32 - High Ambient Air Performance

| | | Composition CO₂/R-32/R-1234ze(E) | | | | | | | |
|---|---|---|---|---|---|---|---|---|---|
| | | % by weight | | | | | | | |
| | | 5/50/45 | 5/55/40 | 5/60/35 | 5/65/30 | 5/67/28 | 5/70/25 | 5/75/20 | 5/80/15 |
| COP | | 2.29 | 2.28 | 2.26 | 2.25 | 2.25 | 2.24 | 2.23 | 2.22 |
| COP relative to Reference (R410A) | | 110.8% | 110.2% | 109.6% | 109.0% | 108.8% | 108.5% | 108.1% | 107.6% |
| Volumetric capacity | kJ/m³ | 3845 | 4010 | 4170 | 4324 | 4385 | 4473 | 4617 | 4756 |
| Capacity relative to Reference (R410A) | | 93.5% | 97.6% | 101.5% | 105.2% | 106.7% | 108.8% | 112.3% | 115.7% |
| Critical temperature | ° C. | 83.7 | 82.6 | 81.6 | 80.7 | 80.3 | 79.8 | 79.0 | 78.2 |
| Critical pressure | bar | 54.5 | 55.4 | 56.1 | 56.8 | 57.1 | 57.5 | 58.1 | 58.6 |
| Refrigeration effect | kJ/kg | 175.6 | 179.4 | 183.2 | 187.1 | 188.6 | 191.0 | 195.0 | 199.0 |
| Pressure ratio | | 4.64 | 4.57 | 4.51 | 4.45 | 4.43 | 4.40 | 4.35 | 4.30 |
| Compressor discharge temperature | ° C. | 125.8 | 128.2 | 130.6 | 132.9 | 133.8 | 135.2 | 137.5 | 139.8 |
| Evaporator inlet pressure | bar | 7.39 | 7.75 | 8.11 | 8.46 | 8.60 | 8.80 | 9.13 | 9.45 |
| Condenser inlet pressure | bar | 33.1 | 34.4 | 35.6 | 36.8 | 37.2 | 37.9 | 38.9 | 39.9 |
| Evaporator inlet temperature | ° C. | 1.1 | 1.5 | 1.9 | 2.3 | 2.5 | 2.7 | 3.1 | 3.5 |
| Evaporator dewpoint | ° C. | 8.9 | 8.5 | 8.1 | 7.7 | 7.5 | 7.3 | 6.9 | 6.5 |
| Evaporator exit gas temperature | ° C. | 13.9 | 13.5 | 13.1 | 12.7 | 12.5 | 12.3 | 11.9 | 11.5 |
| Evaporator glide (out-in) | K | 7.7 | 7.0 | 6.2 | 5.4 | 5.1 | 4.6 | 3.8 | 3.1 |
| Compressor suction pressure | bar | 7.14 | 7.53 | 7.90 | 8.26 | 8.40 | 8.61 | 8.95 | 9.27 |
| Compressor discharge pressure | bar | 33.1 | 34.4 | 35.6 | 36.8 | 37.2 | 37.9 | 38.9 | 39.9 |
| Condenser dew point | ° C. | 64.4 | 63.9 | 63.4 | 63.0 | 62.8 | 62.5 | 62.2 | 61.8 |
| Condenser bubble point | ° C. | 55.6 | 56.1 | 56.6 | 57.0 | 57.2 | 57.5 | 57.8 | 58.2 |
| Condenser exit liquid temperature | ° C. | 50.6 | 51.1 | 51.6 | 52.0 | 52.2 | 52.5 | 52.8 | 53.2 |
| Condenser glide (in-out) | K | 8.9 | 7.8 | 6.8 | 5.9 | 5.6 | 5.1 | 4.3 | 3.6 |

TABLE 11
Theoretical Performance Data of Selected R-744/R-32/R-1234ze(E) blends
containing 6% R-744 and 50-75% R-32 - High Ambient Air Performance

| | | Composition CO₂/R-32/R-1234ze(E) | | | | | | |
|---|---|---|---|---|---|---|---|---|
| | | % by weight | | | | | | |
| | | 6/50/44 | 6/55/39 | 6/60/34 | 6/65/29 | 6/67/27 | 6/70/24 | 6/75/19 |
| COP | | 2.28 | 2.27 | 2.25 | 2.24 | 2.24 | 2.23 | 2.22 |
| COP relative to Reference (R410A) | | 110.3% | 109.7% | 109.1% | 108.5% | 108.3% | 108.0% | 107.6% |
| Volumetric capacity | kJ/m³ | 3936 | 4100 | 4259 | 4413 | 4473 | 4561 | 4704 |
| Capacity relative to Reference (R410A) | | 95.8% | 99.8% | 103.6% | 107.4% | 108.8% | 111.0% | 114.5% |
| Critical temperature | ° C. | 82.8 | 81.8 | 80.9 | 80.0 | 79.6 | 79.2 | 78.4 |
| Critical pressure | bar | 54.9 | 55.8 | 56.6 | 57.3 | 57.6 | 57.9 | 58.5 |
| Refrigeration effect | kJ/kg | 176.3 | 180.0 | 183.8 | 187.6 | 189.1 | 191.4 | 195.4 |
| Pressure ratio | | 4.63 | 4.56 | 4.50 | 4.44 | 4.42 | 4.39 | 4.34 |
| Compressor discharge temperature | ° C. | 126.7 | 129.0 | 131.4 | 133.7 | 134.6 | 136.0 | 138.3 |
| Evaporator inlet pressure | bar | 7.58 | 7.95 | 8.31 | 8.67 | 8.80 | 9.01 | 9.34 |
| Condenser inlet pressure | bar | 34.0 | 35.3 | 36.5 | 37.6 | 38.1 | 38.7 | 39.8 |
| Evaporator inlet temperature | ° C. | 1.0 | 1.4 | 1.8 | 2.2 | 2.3 | 2.6 | 3.0 |
| Evaporator dewpoint | ° C. | 9.0 | 8.6 | 8.2 | 7.8 | 7.7 | 7.4 | 7.0 |
| Evaporator exit gas temperature | ° C. | 14.0 | 13.6 | 13.2 | 12.8 | 12.7 | 12.4 | 12.0 |
| Evaporator glide (out-in) | K | 8.0 | 7.3 | 6.5 | 5.6 | 5.3 | 4.8 | 4.0 |
| Compressor suction pressure | bar | 7.34 | 7.73 | 8.10 | 8.47 | 8.61 | 8.82 | 9.16 |
| Compressor discharge pressure | bar | 34.0 | 35.3 | 36.5 | 37.6 | 38.1 | 38.7 | 39.8 |
| Condenser dew point | ° C. | 64.6 | 64.1 | 63.6 | 63.1 | 62.9 | 62.7 | 62.3 |
| Condenser bubble point | ° C. | 55.4 | 55.9 | 56.4 | 56.9 | 57.1 | 57.3 | 57.7 |
| Condenser exit liquid temperature | ° C. | 50.4 | 50.9 | 51.4 | 51.9 | 52.1 | 52.3 | 52.7 |
| Condenser glide (in-out) | K | 9.2 | 8.1 | 7.1 | 6.2 | 5.8 | 5.3 | 4.6 |

TABLE 12
Theoretical Performance Data of Selected R-744/R-32/R-1234ze(E) blends
containing 8% R-744 and 50-70% R-32 - High Ambient Air Performance

| | | Composition CO₂/R-32/R-1234ze(E) | | | | | |
|---|---|---|---|---|---|---|---|
| | | % by weight | | | | | |
| | | 7/50/43 | 7/55/38 | 7/59/34 | 7/60/33 | 7/65/28 | 7/70/23 |
| COP | | 2.26 | 2.25 | 2.24 | 2.24 | 2.23 | 2.22 |
| COP relative to Reference | | 109.8% | 109.2% | 108.8% | 108.7% | 108.1% | 107.6% |
| Volumetric capacity | kJ/m3 | 4015 | 4180 | 4307 | 4338 | 4492 | 4640 |
| Capacity relative to Reference | | 98.0% | 102.0% | 105.1% | 105.9% | 109.6% | 113.2% |
| Critical temperature | ° C. | 82.0 | 81.1 | 80.3 | 80.2 | 79.3 | 78.5 |
| Critical pressure | bar | 55.3 | 56.2 | 56.9 | 57.0 | 57.7 | 58.4 |
| Refrigeration effect | kJ/kg | 177.0 | 180.6 | 183.6 | 184.3 | 188.1 | 191.9 |
| Pressure ratio | | 4.64 | 4.57 | 4.52 | 4.51 | 4.45 | 4.39 |
| Compressor discharge temperature | ° C. | 127.7 | 130.1 | 131.9 | 132.4 | 134.7 | 136.9 |
| Evaporator inlet pressure | bar | 7.80 | 8.17 | 8.46 | 8.53 | 8.89 | 9.23 |
| Condenser inlet pressure | bar | 34.9 | 36.2 | 37.1 | 37.4 | 38.5 | 39.6 |
| Evaporator inlet temperature | ° C. | 0.9 | 1.3 | 1.6 | 1.7 | 2.1 | 2.5 |
| Evaporator dewpoint | ° C. | 9.1 | 8.7 | 8.4 | 8.3 | 7.9 | 7.5 |
| Evaporator exit gas temperature | ° C. | 14.1 | 13.7 | 13.4 | 13.3 | 12.9 | 12.5 |
| Evaporator glide (out-in) | K | 8.2 | 7.4 | 6.7 | 6.6 | 5.7 | 4.9 |
| Compressor suction pressure | bar | 7.53 | 7.91 | 8.22 | 8.29 | 8.66 | 9.02 |
| Compressor discharge pressure | bar | 34.9 | 36.2 | 37.1 | 37.4 | 38.5 | 39.6 |
| Condenser dew point | ° C. | 64.8 | 64.2 | 63.8 | 63.7 | 63.2 | 62.8 |
| Condenser bubble point | ° C. | 55.2 | 55.8 | 56.2 | 56.3 | 56.8 | 57.2 |
| Condenser exit liquid temperature | ° C. | 50.2 | 50.8 | 51.2 | 51.3 | 51.8 | 52.2 |
| Condenser glide (in-out) | K | 9.6 | 8.5 | 7.6 | 7.4 | 6.5 | 5.6 |

TABLE 13
Theoretical Performance Data of Selected R-744/R-32/R-1234ze(E) blends
containing 8% R-744 and 50-70% R-32 - High Ambient Air Performance

| | | Composition CO₂/R-32/R-1234ze(E) | | | | | |
|---|---|---|---|---|---|---|---|
| | | % by weight | | | | | |
| | | 8/50/42 | 8/55/37 | 8/60/32 | 8/65/27 | 8/67/25 | 8/70/22 |
| COP | | 2.26 | 2.25 | 2.23 | 2.22 | 2.22 | 2.21 |
| COP relative to Reference (R410A) | | 109.3% | 108.7% | 108.1% | 107.5% | 107.3% | 107.0% |
| Volumetric capacity | kJ/m³ | 4116 | 4279 | 4436 | 4588 | 4648 | 4735 |
| Capacity relative to Reference (R410A) | | 100.1% | 104.1% | 107.9% | 111.6% | 113.1% | 115.2% |
| Critical temperature | ° C. | 81.2 | 80.3 | 79.5 | 78.7 | 78.3 | 77.9 |
| Critical pressure | bar | 55.8 | 56.6 | 57.4 | 58.2 | 58.4 | 58.8 |
| Refrigeration effect | kJ/kg | 177.5 | 181.1 | 184.8 | 188.5 | 190.0 | 192.2 |
| Pressure ratio | | 4.62 | 4.55 | 4.49 | 4.43 | 4.41 | 4.38 |
| Compressor discharge temperature | ° C. | 128.4 | 130.7 | 133.0 | 135.3 | 136.2 | 137.5 |
| Evaporator inlet pressure | bar | 7.97 | 8.35 | 8.72 | 9.08 | 9.22 | 9.42 |
| Condenser inlet pressure | bar | 35.8 | 37.0 | 38.2 | 39.4 | 39.8 | 40.4 |
| Evaporator inlet temperature | ° C. | 0.7 | 1.1 | 1.5 | 2.0 | 2.1 | 2.4 |
| Evaporator dewpoint | ° C. | 9.3 | 8.9 | 8.5 | 8.0 | 7.9 | 7.6 |
| Evaporator exit gas temperature | ° C. | 14.3 | 13.9 | 13.5 | 13.0 | 12.9 | 12.6 |
| Evaporator glide (out-in) | K | 8.7 | 7.8 | 6.9 | 6.1 | 5.7 | 5.2 |
| Compressor suction pressure | bar | 7.75 | 8.14 | 8.52 | 8.89 | 9.03 | 9.24 |
| Compressor discharge pressure | bar | 35.8 | 37.0 | 38.2 | 39.4 | 39.8 | 40.4 |
| Condenser dew point | ° C. | 64.9 | 64.3 | 63.8 | 63.3 | 63.1 | 62.9 |
| Condenser bubble point | ° C. | 55.1 | 55.7 | 56.2 | 56.7 | 56.9 | 57.1 |
| Condenser exit liquid temperature | ° C. | 50.1 | 50.7 | 51.2 | 51.7 | 51.9 | 52.1 |
| Condenser glide (in-out) | K | 9.8 | 8.6 | 7.6 | 6.6 | 6.3 | 5.8 |

TABLE 14
Theoretical Performance Data of Selected R-744/R-32/R-1234ze(E) blends containing
10 or 12% R-744 and 50-60% R-32 - High Ambient Air Performance

| | | Composition CO₂/R-32/R-1234ze(E) | | | | | |
|---|---|---|---|---|---|---|---|
| | | % by weight | | | | | |
| | | 10/50/40 | 10/55/35 | 10/60/30 | 12/50/38 | 12/55/33 | 12/60/28 |
| COP | | 2.24 | 2.22 | 2.21 | 2.21 | 2.20 | 2.19 |
| COP relative to Reference (R410A) | | 108.3% | 107.6% | 107.0% | 107.2% | 106.5% | 105.9% |
| Volumetric capacity | kJ/m³ | 4296 | 4456 | 4612 | 4473 | 4632 | 4786 |
| Capacity relative to Reference (R410A) | | 104.5% | 108.4% | 112.2% | 108.8% | 112.7% | 116.4% |
| Critical temperature | ° C. | 79.7 | 78.9 | 78.1 | 78.2 | 77.5 | 76.8 |
| Critical pressure | bar | 56.6 | 57.5 | 58.3 | 57.4 | 58.4 | 59.2 |
| Refrigeration effect | kJ/kg | 178.6 | 182.0 | 185.5 | 179.4 | 182.7 | 186.1 |
| Pressure ratio | | 4.60 | 4.53 | 4.47 | 4.57 | 4.51 | 4.45 |
| Compressor discharge temperature | ° C. | 130.0 | 132.3 | 134.5 | 131.6 | 133.8 | 136.1 |
| Evaporator inlet pressure | bar | 8.38 | 8.76 | 9.14 | 8.80 | 9.19 | 9.57 |
| Condenser inlet pressure | bar | 37.5 | 38.8 | 40.0 | 39.3 | 40.6 | 41.7 |
| Evaporator inlet temperature | ° C. | 0.4 | 0.9 | 1.3 | 0.2 | 0.7 | 1.1 |
| Evaporator dewpoint | ° C. | 9.6 | 9.1 | 8.7 | 9.8 | 9.3 | 8.9 |
| Evaporator exit gas temperature | ° C. | 14.6 | 14.1 | 13.7 | 14.8 | 14.3 | 13.9 |
| Evaporator glide (out-in) | K | 9.2 | 8.3 | 7.4 | 9.6 | 8.7 | 7.7 |
| Compressor suction pressure | bar | 8.17 | 8.56 | 8.95 | 8.59 | 9.00 | 9.38 |
| Compressor discharge pressure | bar | 37.5 | 38.8 | 40.0 | 39.3 | 40.6 | 41.7 |
| Condenser dew point | ° C. | 65.1 | 64.5 | 64.0 | 65.2 | 64.6 | 64.1 |
| Condenser bubble point | ° C. | 54.9 | 55.5 | 56.0 | 54.8 | 55.4 | 55.9 |
| Condenser exit liquid temperature | ° C. | 49.9 | 50.5 | 51.0 | 49.8 | 50.4 | 50.9 |
| Condenser glide (in-out) | K | 10.2 | 9.0 | 7.9 | 10.5 | 9.3 | 8.2 |

1. A heat transfer composition comprising up to about 30% by weight carbon dioxide (R-744), from about 30% to about 80% by weight difluoromethane (R-132), and trans-1,3,3,3-tetrafluoropropene (R-1234ze(E)).

2. A composition according to claim 1 comprising from about 4% to about 30% by weight R-744.

3. A composition according to claim 1 comprising from about 45% to about 80% by weight R-32.

4. A composition according to claim 1 wherein the amount of R-32 is such that the mean condensing pressure is maintained within 0.5 bar of the equivalent condensing pressure obtained using R-410A, and/or such that the compressor discharge temperature is lower than that obtained using R-410A

5. A composition according to claim 1 comprising from about 4 to about 12% by weight R-744, from about 45 to about 80% by weight R-32 and from about 8% to about 51% by weight R-1234ze(E).

6. A composition according to claim 5 comprising from about 6 to about 10% by weight R-744, from about 55 to about 75% by weight R-32 and from about 15% to about 39% by weight R-1234ze(E).

7. A composition according to claim 5 comprising from about 4 to about 8% by weight R-744, from about 65 to about 70% R-32 and from about 22% to about 31% by weight R-1234ze(E).

8. A composition according to claim 1 wherein the condenser temperature glide is less than about 15 K.

9. A composition according to claim 1 wherein the evaporator temperature glide is less than about 10 K.

10. A composition according to claim 1 which has a critical temperature of greater than about 70° C.

11. A composition according to claim 1, wherein the composition has a GWP of less than 1000.

12. A composition according to claim 1 wherein the composition has a volumetric refrigeration capacity at least about 90% of an existing refrigerant that it is intended to replace.

13. A composition according to claim 1, wherein the composition is less flammable than R-32 alone.

14. A composition according to claim 13 wherein the composition has:
(a) a narrower flammable range;
(b) a higher ignition energy; and/or
(c) a lower flame velocity
compared to R-32 alone.

15. A composition according to claim 1 which has a fluorine ratio (F/(F+H)) of from about 0.44 to about 0.67.

16. A composition according to claim 1 which is non-flammable.

17. A composition according to claim 1, wherein the composition has a cycle efficiency at least about 95% of the existing refrigerant that it is intended to replace.

18. A composition according to claim 1, wherein the composition has a compressor discharge temperature within about 15 K of an existing refrigerant that it is intended to replace.

19. A composition comprising a lubricant and a composition according to claim 1.

20. A composition according to claim 19, wherein the lubricant is selected from mineral oil, silicone oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof.

21. A composition according to claim 19 further comprising a stabiliser.

22. A composition according to claim 21, wherein the stabiliser is selected from diene-based compounds, phosphates, phenol compounds and epoxides, and mixtures thereof.

23. A composition comprising a flame retardant and a composition according to claim 1.

24. A composition according to claim 23, wherein the flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

25. (canceled)

26. A heat transfer device containing a composition as defined in claim 1.

27. (canceled)

28. A heat transfer device according to claim 26 which is a refrigeration device.

29. A heat transfer device according to claim 28 which is selected from group consisting of automotive air conditioning systems, residential air conditioning systems, commercial air conditioning systems, residential refrigerator systems, residential freezer systems, commercial refrigerator systems, commercial freezer systems, chiller air conditioning systems, chiller refrigeration systems, and commercial or residential heat pump systems, preferably wherein the heat transfer device is an automobile air-conditioning system.

30. A heat transfer device according to claim 28 which contains a compressor.

31. A blowing agent comprising a composition as defined in claim 1.

32. A foamable composition comprising one or more components capable of forming foam and a composition as defined in claim 1, wherein the one or more components capable of forming foam are selected from polyurethanes, thermoplastic polymers and resins, such as polystyrene, and epoxy resins, and mixtures thereof.

33. (canceled)

34. A foam comprising a composition as defined in claim 1.

35. A sprayable composition comprising material to be sprayed and a propellant comprising a composition as defined in claim 1.

36. A method for cooling an article which comprises condensing a composition defined in claim 1 and thereafter evaporating the composition in the vicinity of the article to be cooled.

37. A method for heating an article which comprises condensing a composition as defined in claim 1 in the vicinity of the article to be heated and thereafter evaporating the composition.

38. A method for extracting a substance from biomass comprising contacting biomass with a solvent comprising a composition as defined in claim 1, and separating the substance from the solvent.

39. A method of cleaning an article comprising contacting the article with a solvent comprising a composition as defined in claim 1.

40. A method of extracting a material from an aqueous solution or a particulate solid matrix comprising contacting the aqueous solution or the articulate solid matrix with a solvent comprising a composition as defined in claim 1, and separating the material from the solvent.

41. (canceled)

42. A mechanical power generation device containing a composition as defined in claim 1.

43. A mechanical power generating device according to claim 42 which is adapted to use a Rankine Cycle or modification thereof to generate work from heat.

44. A method of retrofitting a heat transfer device comprising the step of removing an existing heat transfer fluid, and introducing a composition as defined in claim 1.

45. A method of claim 44 wherein the heat transfer device is a refrigeration device.

46. A method according to claim 45 wherein the heat transfer device is an air conditioning system.

47. A method for reducing the environmental impact arising from the operation of a product comprising an existing compound or composition, the method comprising replacing at least partially the existing compound or composition with a composition as defined in claim 1.

48. A method for preparing a composition as defined in claim 1, the method comprising introducing R-744, R-1234ze(E), and optionally, a lubricant, a stabiliser and/or a flame retardant, into a heat transfer device containing an existing heat transfer fluid which is R-32.

49. A method according to claim 48 comprising the step of removing at least some of the existing R-32 from the heat transfer device before introducing the R-1234ze(E), R-744, and optionally, the lubricant, the stabiliser and/or the flame retardant.

50. A method for generating greenhouse gas emission credit comprising (i) replacing an existing compound or composition with a composition as defined in claim 1, wherein the composition as defined in claim 1 has a lower GWP than the existing compound or composition; and (ii) obtaining greenhouse gas emission credit for said replacing step.

51. A method of claim 50 wherein the use of the composition of the invention results in a lower Total Equivalent Warming Impact, and/or a lower Life-Cycle Carbon Production than is attained by use of the existing compound or composition.

52. A method of claim 50 carried out on a product from the fields of air-conditioning, refrigeration, heat transfer, blowing agents, aerosols or sprayable propellants, gaseous dielectrics, cryosurgery, veterinary procedures, dental procedures, fire extinguishing, flame suppression, solvents, cleaners, air horns, pellet guns, topical anesthetics, and expansion applications.

53. A method according to claim 47 wherein the product is selected from a heat transfer device, a blowing agent, a foamable composition, a sprayable composition, a solvent or a mechanical power generation device.

54. (canceled)

55. (canceled)

56. A method according to claim 52 wherein the existing compound or composition is a refrigerant selected from R-404A, R-410A, R-507, R-407A, R-407B, R-407D, R-407E and R-407F.

57. (canceled)

58. A composition according to claim 2 comprising from about 4% to about 12% by weight R-744.

59. A composition according to claim 8 wherein the condenser temperature glide is less than about 10 K.

60. A composition according to claim 12 wherein the composition has a volumetric refrigeration capacity at least about 95% of the existing refrigerant that it is intended to replace.

61. A composition according to claim 18, wherein the composition has a compressor discharge temperature within about 15 K of an existing refrigerant that it is intended to replace.
